(19) United States
(12) Patent Application Publication
(10) Pub. No.: US 2013/0197927 A1
(43) Pub. Date: Aug. 1, 2013

(54) HEALTHCARE VALIDATION SYSTEM

(71) Applicant: CareFusion 303, Inc., San Diego, CA (US)

(72) Inventors: Timothy W. Vanderveen, Poway, CA (US); Federico Garibaldi, Encinitas, CA (US)

(73) Assignee: CareFusion 303, Inc., San Diego, CA (US)

(21) Appl. No.: 13/802,433

(22) Filed: Mar. 13, 2013

Related U.S. Application Data
(63) Continuation-in-part of application No. 09/860,865, filed on May 18, 2001.
Application No. 09/860,865 is a continuation-in-part of application No. 10/361,704, filed on Feb. 9, 2003.
Application No. 10/361,704 is a continuation-in-part of application No. 10/750,032, filed on Dec. 31, 2003.
Application No. 10/750,032 is a continuation-in-part of application No. 13/246,782, filed on Sep. 27, 2011.
Application No. 13/246,782 is a continuation of application No. 12/947,773, filed on Nov. 16, 2010, now Pat. No. 8,340,792.
Application No. 12/947,773 is a continuation of application No. 10/925,511, filed on Aug. 25, 2004, now Pat. No. 7,860,583.
Application No. 10/925,511 is a continuation-in-part of application No. 11/326,145, filed on Dec. 30, 2005.
(60) Provisional application No. 60/205,125, filed on May 18, 2000.
(60) Provisional application No. 60/652,382, filed on Feb. 11, 2005.

(51) Int. Cl. G06F 19/00

(52) U.S. Cl. CPC G06F 19/3462
USPC 705/2

(57) ABSTRACT

A healthcare validation system may include a processor and a memory. The memory may include instructions that, when executed by the processor, cause the processor to receive an order for a medication from a healthcare system, receive, from at least one healthcare device, at least one information item pertaining to progress of delivery of the medication to a patient, wherein the at least one healthcare device facilitates the delivery of the medication to the patient, validate the medication being delivered to the patient based at least in part on the received order and the received at least one information item, and store an indication of whether the medication being delivered to the patient was validated. In one or more embodiments, the processor may provide an alert to a user device of a healthcare professional when the medication being delivered to the patient is not validated.

### CROSS-REFERENCE TO RELATED APPLICATIONS

The present application is a continuation-in-part of co-pending U.S. patent application Ser. No. 09/860,865, entitled “Distributed Remote Asset and Medication Management Drug Delivery System,” filed on May 18, 2001, which claims priority to U.S. Provisional Patent Application Ser. No. 60/205,125, entitled “Distributed remote asset and medication management drug delivery system (DRAMMDDS),” filed on May 18, 2000, both of which are hereby incorporated by reference in their entirety for all purposes. The present application is also a continuation-in-part of co-pending U.S. patent application Ser. No. 10/361,704, entitled “Medication Management and Event Logger and Analysis System,” filed on Feb. 9, 2003, which is hereby incorporated by reference in its entirety for all purposes. The present application is also a continuation-in-part of co-pending U.S. patent application Ser. No. 10/750,032, entitled “Centralized Medication Management System,” filed on Dec. 31, 2003, which is hereby incorporated by reference in its entirety for all purposes. The present application is also a continuation-in-part of co-pending U.S. patent application Ser. No. 13/246,782, entitled “System and Method for Dynamically Adjusting Patient Therapy,” filed on Sept. 27, 2011, which is a continuation of U.S. patent application Ser. No. 12/947,773, entitled “System and Method for Dynamically Adjusting Patient Therapy,” filed on Nov. 16, 2010, now issued as U.S. Pat. No. 8,340,792, which is a continuation of U.S. patent application Ser. No. 10/925,511, entitled “System and Method for Dynamically Adjusting Patient Therapy,” filed on Aug. 25, 2004, now issued as U.S. Pat. No. 7,860,583, all of which are hereby incorporated by reference in their entirety for all purposes. The present application is also a continuation-in-part of co-pending U.S. patent application Ser. No. 11/326,145, entitled “Management of Pending Medication Orders,” filed on Dec. 30, 2005, which claims priority to U.S. Provisional Patent Application Ser. No. 60/652,382, entitled “Management of Pending Medication Orders,” filed on Feb. 11, 2005, both of which are hereby incorporated by reference in their entirety for all purposes.

### TECHNICAL FIELD

The present description relates generally to a validation system, and more particularly, but not exclusively, to a healthcare validation system.

### BACKGROUND

Healthcare facilities, such as hospitals, may utilize many different user devices, healthcare devices, and/or healthcare systems to facilitate with providing healthcare to patients. For example, a healthcare facility may utilize healthcare systems to facilitate with providing healthcare to patients, such as through physician order entry systems, pharmacy information systems, hospital information systems, etc. The healthcare facility may also utilize healthcare devices to facilitate with providing healthcare to patients, such as infusion devices, dispensing devices, respiratory devices, etc. In addition, the healthcare facility may utilize user devices to facilitate with providing healthcare to patients, such as computing stations that are located throughout the health facility, personal digital assistants (PDAs) that are carried by health care professionals, etc. However, communication barriers between these systems and/or devices may prevent the healthcare facility from providing efficient and effective healthcare to patients.

For example, a pharmacy in a healthcare facility may prepare ordered medications to be administered to patients, but the pharmacy may be unable to determine whether the medications were actually administered. A healthcare device may facilitate with administering a medication to a patient, but the healthcare device may be unable to determine whether the medication being administered to the patient corresponds to the medication that was ordered for the patient. An accounting system may be able to bill a patient for an administered medication, but the accounting system may be unable to determine an amount of the medication that was administered.

### SUMMARY

The disclosed subject matter relates to a method for validating medications being delivered to patients. The method may include receiving an order for a medication from a healthcare system. The method may further include receiving, from at least one healthcare device, at least one information item pertaining to progress of delivery of the medication to a patient, wherein the at least one healthcare device facilitates the delivery of the medication to the patient. The method may further include validating the medication being delivered to the patient based at least in part on the received order and the received at least one information item. The method may further include storing an indication of whether the medication being delivered to the patient was validated.

The disclosed subject matter also relates to a non-transitory machine readable medium embodying instructions that, when executed by a machine, cause the machine to perform a method for validating healthcare transactions. The method may include receiving an order for administration of a medication to a patient with facilitation of a healthcare device. The method may further include generating and storing a transaction for the order, wherein the transaction comprises a plurality of line items corresponding to a plurality of actions related to the order, wherein a first line item corresponds to transmitting the order to the healthcare device, a second line item corresponds to completing the administration of the order to the patient with the facilitation of the healthcare device, and a third line item corresponds to updating an accounting system with respect to the administration of the order to the patient. The method may further include receiving a first message that indicates that the order has been transmitted to the healthcare device. The method may further include receiving a second message that indicates that the administration of the order to the patient has been completed. The method may further include receiving a third message that indicates that the accounting system has been updated with respect to the administration of the order to the patient, and validating the transaction when the first, second, and third messages are received.

The disclosed subject matter also relates to a system. The system may include one or more processors and a memory. The memory may include instructions that, when executed by the one or more processors, cause the one or more processors to: receive a plurality of orders from a healthcare system over a communication network, each order identifying one of a plurality of medications to be delivered to one of a plurality of patients, receive a plurality of information items from a plurality of healthcare devices, each information item pertaining to a progress of delivery of one of the plurality of medications to one of the plurality of patients, the delivery being facilitated by one of the plurality of healthcare devices, provide at least a portion of the plurality of information items and at least a portion of the plurality of orders for display, receive an indication that a discrepancy exists between one of the plurality of information items and a corresponding one of the plurality of orders, and store the indication in a data store.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a healthcare validation system may be implemented in accordance with one or more embodiments.

FIG. 2 illustrates an example messaging architecture in which a healthcare validation system may be implemented in accordance with one or more embodiments.

FIG. 3 illustrates an alternative example messaging architecture in which a healthcare validation system may be implemented in accordance with one or more embodiments.

FIG. 4 illustrates a flow diagram of an example process for a healthcare validation system in accordance with one or more embodiments.

FIG. 5 illustrates a flow diagram of an example process for a healthcare validation system in accordance with one or more embodiments.

FIG. 6 illustrates a flow diagram of an example process for a healthcare validation system in accordance with one or more embodiments.

FIG. 7 illustrates an example user interface that may be implemented in a healthcare validation system in accordance with one or more embodiments.

FIG. 8 illustrates an example user interface that may be implemented in a healthcare validation system in accordance with one or more embodiments.

FIG. 9 illustrates an example user interface that may be implemented in a healthcare validation system in accordance with one or more embodiments.

FIG. 10 illustrates an example user interface that may be implemented in a healthcare validation system in accordance with one or more embodiments.

FIG. 11 conceptually illustrates an electronic system with which one or more embodiments of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, well-known structures and components are shown in block diagram form in order to avoid obscuring the concepts of the subject technology.

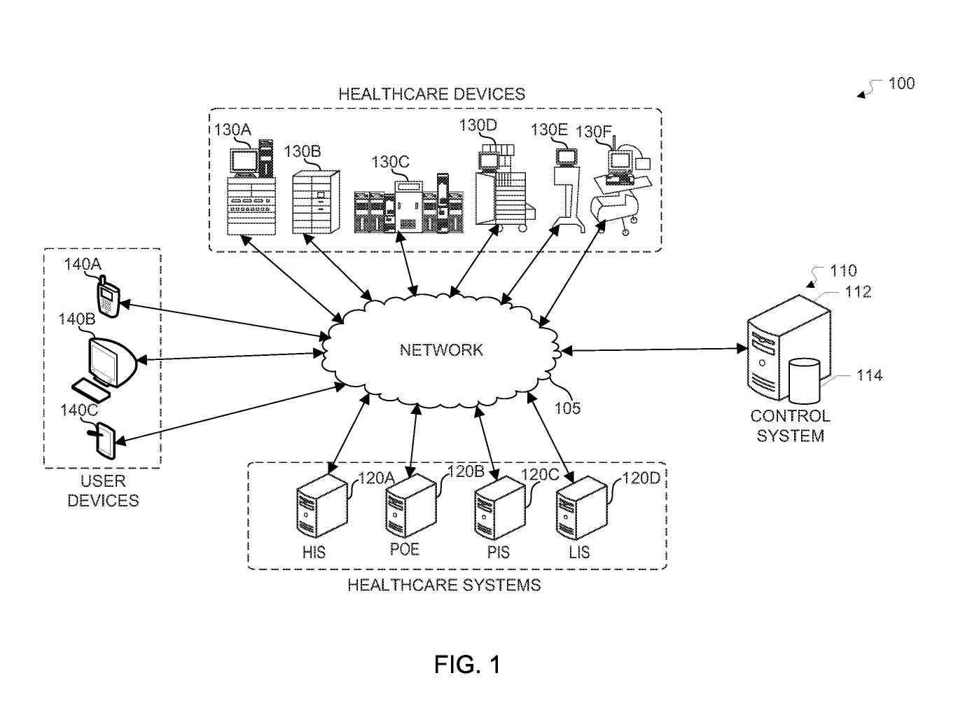

FIG. 1 illustrates an example network environment 100 in which a healthcare validation system may be implemented in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

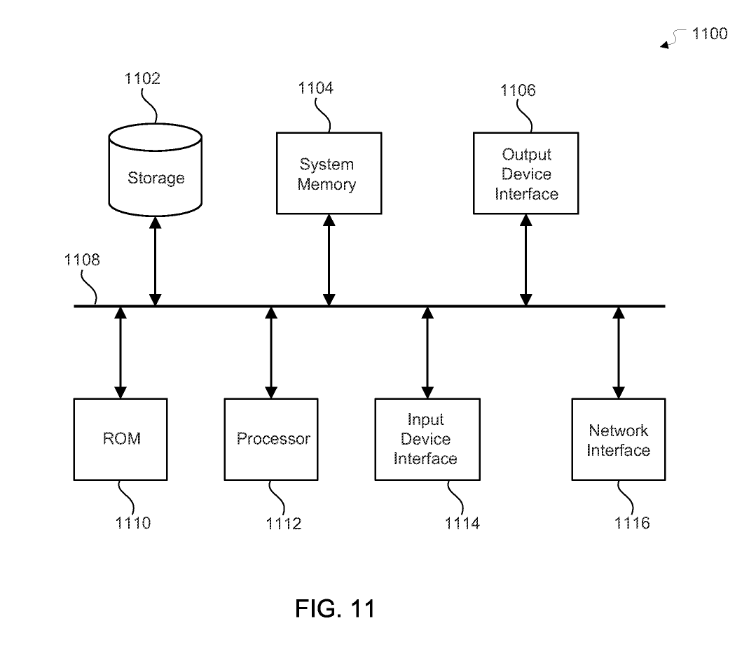

The network environment 100 includes network 105, a control system 110, one or more healthcare systems 120A-D, one or more healthcare devices 130A-F, and one or more user devices 140A-C. The control system 110, healthcare systems 120A-D, healthcare devices 130A-F, and/or user devices 140A-C may be communicatively coupled to one another, such as by the network 105. In one or more embodiments, one or more of the control system 110, healthcare systems 120A-D, healthcare devices 130A-F, or user devices 140A-C may be directly coupled to one another. In addition, there may be a number of other devices connected to the network 105, such as additional healthcare systems, e.g. other clinical and/or logistical systems, additional healthcare devices, external systems, computing devices, mobile devices, etc. The control system 110, one or more healthcare systems 120A-D, one or more healthcare devices 130A-F, and/or one or more user devices 140A-C may be, or may include all or part of, the electronic system that is discussed further below with respect to FIG. 11.

The network 105 may be a communication network, such as a public communication network (such as the Internet, cellular data network, dialup modems over a telephone network), a private communications network (such as private local area network (“LAN”), leased lines), etc. The network 105 may also include, but is not limited to, any one or more of the following network topologies, including a bus network, a star network, a ring network, a mesh network, a star-bus network, a tree or hierarchical network, and the like. The connections of the network 105 may be wired or wireless. For example, one or more of the control system 110, healthcare systems 120A-D, healthcare devices 130A-F, and/or user devices 140A-C may transmit wireless signals over the network 105, such as radio frequency (RF) signals, infrared (IR) signals, Bluetooth signals, or any other means capable of carrying information in a wireless manner between devices having appropriate transmitters and/or receivers.

The control system 110 may be a single computing device such as a computer server. Alternatively, the control system 110 may represent one or more computing devices (such as a cloud of computers and/or a distributed system) that are communicatively coupled, such as communicatively coupled over the network 105, and that collectively, or individually, perform one or more functions that can be performed server-side, such as receiving messages, transmitting messages, storing messaging, receiving control commands, providing user interfaces, transmitting notifications, etc. The one or more computing devices of the control system 110 may be geographically collocated and/or the one or more computing devices of the control system 110 may be disparately located. The control system 110 may be coupled with various databases, such as data store 114, storage services, or other computing devices. The control system 110, and the coupled databases, storage services, or other computing devices may be geographically collocated, or may be disparately located. In one or more embodiments, the control system 110 includes a processing device 112 and a data store 114. The processing device 112 executes computer instructions stored in the data store 114. In one or more embodiments, the data store 114 may store the computer instructions on non-transitory computer-readable medium.

The one or more healthcare systems 120A-D may be any systems that facilitate with providing healthcare, and/or provide healthcare. In FIG. 1, the healthcare system 120A is a hospital information system (HIS), the healthcare system 120B is a physician order entry (POE) system, the healthcare system 120C is a pharmacy information system (PIS), and the healthcare system 120D is a laboratory information system (LIS). The HIS may, for example, store information pertaining to the administration of the healthcare facility, such as a hospital. The HIS may provide, and/or may interface with a server that provides, billing and accounting functions. The POE system may be used, for example, by physicians to enter orders for patients, such as orders for medications to be administered to patients, that are then transmitted to the PIS.

The PIS may store, for example, information pertaining to a pharmacy of a healthcare facility, such as outstanding orders, filled orders, patient medical profiles/histories, etc. For example, the PIS may provide a library of drug allergies and adverse drug interactions against which each incoming order, or prescription, is checked as part of the order entering/drug dispensing process to identify possible allergies and adverse drug interactions and help in preventing administration of drugs to a patient where the patient might be injured by the prescribed course of therapy. Additionally, the PIS may check to determine if any therapies are being duplicated, such as where two or more drugs might be used to treat a diagnosed disease, whether they are synergistic or antagonistic, and whether the prescribed therapy should be modified accordingly. The LIS may store laboratory results, such as for tests performed to facilitate with providing healthcare to patients.

The healthcare devices 130A-F may include infusion devices, such as infusion pumps, drug delivery devices, dispensing devices, such as automated dispensing machines, smart beds, monitoring devices, respiratory devices, such as ventilators, waste devices, such as drug disposal devices, or generally any device that may facilitate with providing healthcare and/or may provide healthcare. The healthcare devices 130A-F may include a processor and memory. Alternatively, or in addition, the healthcare devices 130A-F may be communicatively coupled to a device that includes a processor and a memory, such as via a serial port.

For example, the healthcare devices 130A-F may include Pyxis Medstations™ to store and dispense medications at the nurses stations, providing distributed access to the medications needed to treat patients, Pyxis® Anesthesia Systems to store and manage the medications used by anesthesiologists in the operating room, Pyxis SpecialtyStations™ to store specific medications and supplies in individual treatment areas, and Pyxis OncologyStations™ in oncology departments to manage the specialized and hazardous medications used to treat cancer. The healthcare devices 130A-F may also include waste devices that accept and store wasted medications, e.g. excess medications, from healthcare professionals and track the amount of medications wasted by healthcare professionals. In one or more embodiments, one or more of the waste devices may be a Pyxis EcoStation™ system.

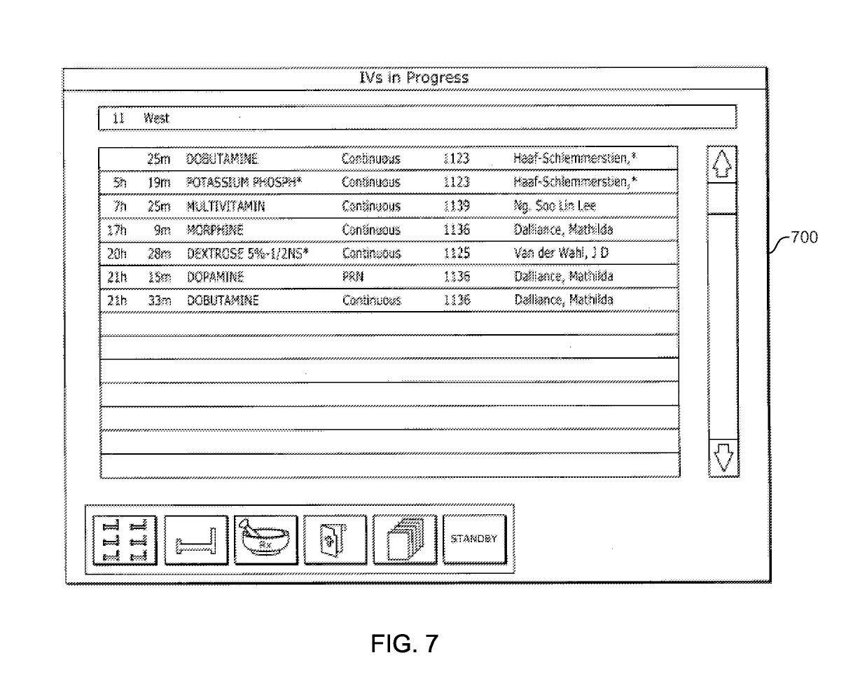

The user devices 140A-C may be electronic devices such as laptop or desktop computers, mobile phones, personal digital assistants (“PDAs”), portable media players, tablet computers, televisions or other displays, or other appropriate computing devices that can be used to display user interfaces that facilitate providing healthcare to patients, such as user interfaces that display information related to providing healthcare to patients and/or user interfaces that allow a healthcare professional, such as a doctor or nurse, access, create, and/or modify information related to providing healthcare to patients, such as modifying a schedule for preparing IVs in the PIS. Example user interfaces are discussed further below with respect to FIGS. 7-10. In the example of FIG. 1, the user device 140A is depicted as a mobile phone, the user device 140B is depicted as a desktop computer, and the user device 140C is depicted as a personal digital assistant (“PDA”), e.g. a tablet device. In one or more embodiments, the user devices 140A-C may include a processor and a memory.

In operation, the control system 110, the healthcare systems 120A-D, the healthcare devices 130A-F, and/or the user devices 140A-C may transmit electronic data streams to one another over the network 105. The electronic data streams may include, for example, messages, and one or more of the messages may be referred to as a medical transaction carrier (MTC). The messages may relate to healthcare that is being facilitated by any of the healthcare systems 120A-D, the healthcare devices 130A-F, and/or the user devices 140A-C. For example, a message may include an order for a medication that is transmitted from a POE system to a PIS. In one or more embodiments, at least a portion of the message, and/or a second message related to the message, may be transmitted by the PIS to a healthcare device 130A, such as to indicate that the ordered medication should be administered to the patient. Alternatively, or in addition, a message may relate to the progress of the delivery of medication, such as by one or more of the healthcare devices 130A-F. For example, the healthcare device 130A may transmit a message to the PIS that indicates the progress of delivering the medication by the healthcare device 130A to the patient. For example, the message may indicate that the healthcare device 130A has started delivering the medication, the healthcare device 130A has delivered an indicated amount of the medication, or the healthcare device 130A has completed the delivery of the medication.

The control system 110 and/or one or more of the healthcare systems 120A-D, such as the healthcare system 120C (PIS), may utilize the messages regarding the orders of medications for patients, and/or the messages regarding the progress of delivering the medications to the patients, to validate that the correct medications are being delivered to the patients, e.g. the correct type of medication, the correct rate of delivery, the correct amount of medication, etc. For example, the control system 110 may provide information regarding the medications that were ordered for patients, and information regarding the medications that are being delivered to patients, to one or more of the user devices 140A-C and/or a display. A healthcare professional may compare the ordered medications and the medications being delivered, e.g. as displayed on the user device 140A, to determine if there are any discrepancies. For example, a discrepancy may exist if there is information indicating that an anticoagulant should be infusing but no information indicating that an anticoagulant is being infused, e.g. no information transmitted from an infusion pump to the pharmacy. In one or more embodiments, a discrepancy may be based on guardrails set for an infusion. For example, a discrepancy may exist if there is information indicating that a hard dose limit of an infusion has been experienced, the infusion has been cancelled, the same rate/dose is underway as a basic infusion (e.g. no drug associated with the infusion), a soft limit has been experienced, and the dose limit has been overridden.

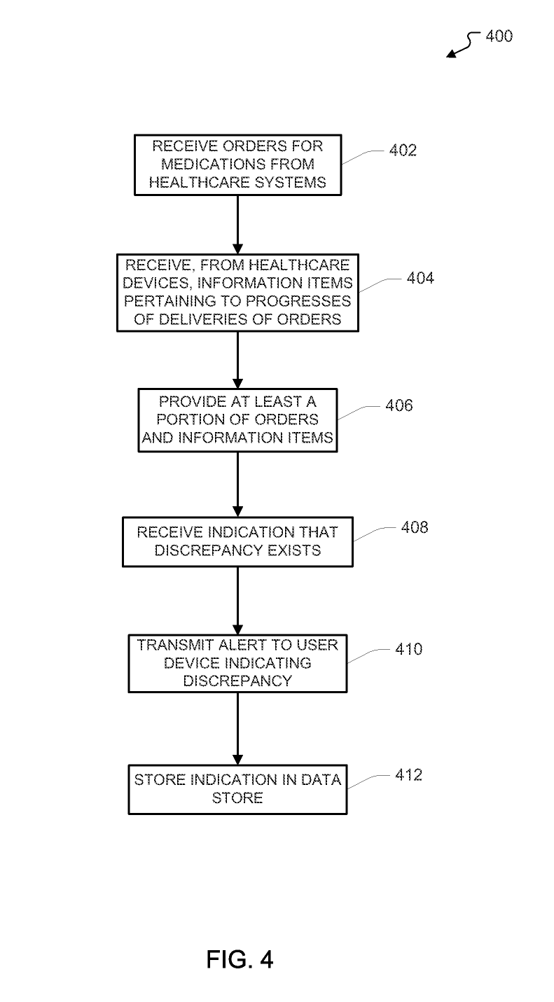

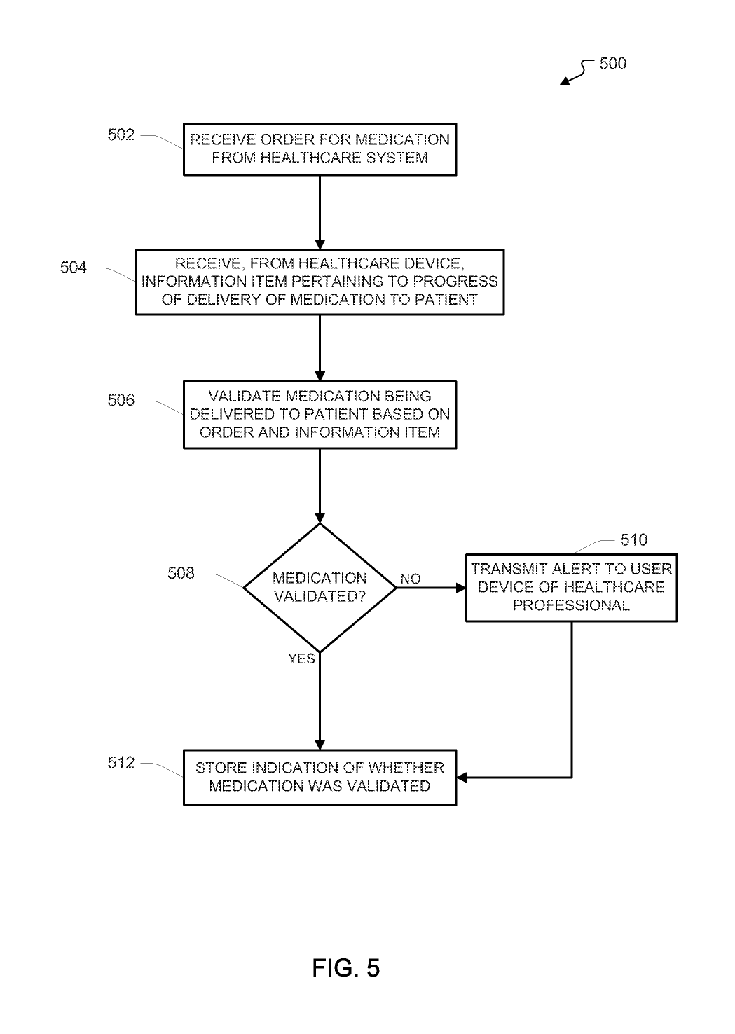

The healthcare professional may interact with the user device 140A to identify a discrepancy, and the user device 140A may transmit an indication of the discrepancy to the control system 110. In one or more embodiments, the control system 110 may compare information pertaining to an ordered medication against information pertaining to a medication being delivered to determine if there are any discrepancies, e.g. without the intervention of a healthcare professional. Example processes for validating medications are discussed further below with respect to FIGS. 4 and 5.

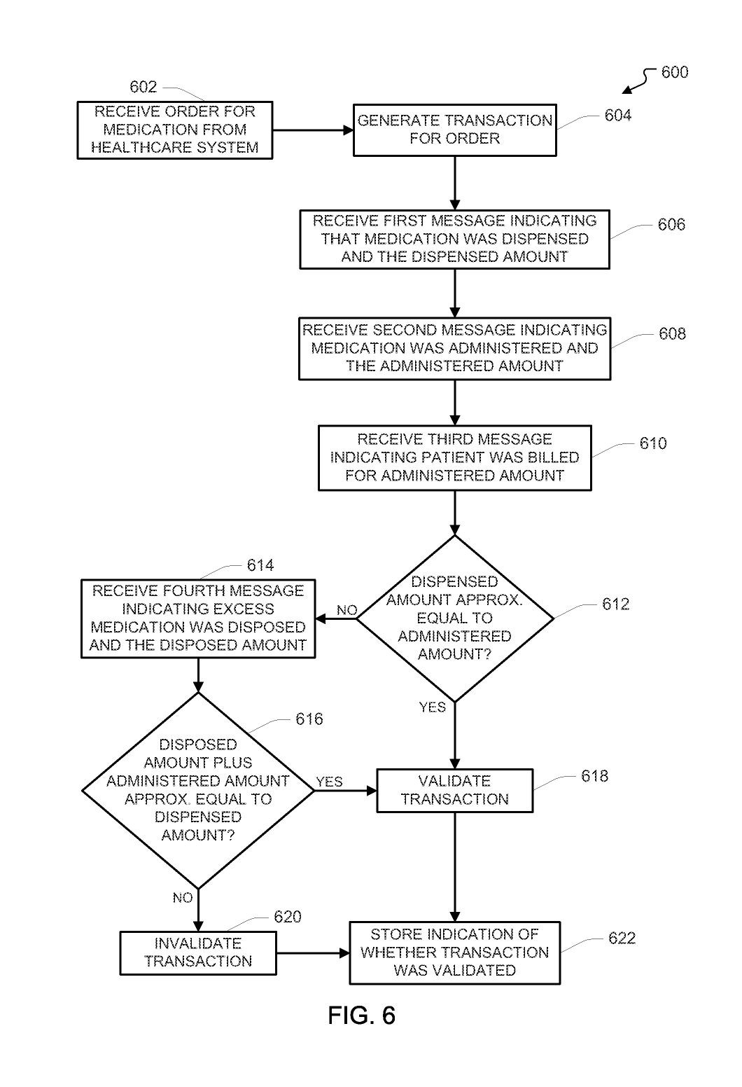

In one or more embodiments, the control system 110 may utilize messages transmitted by the healthcare systems 120A-D, and/or the healthcare devices 130A-F, to validate the completion of a healthcare transaction. For example, when an order is entered into the healthcare system 120B (POE), and/or is received by the healthcare system 120C (PIS), the control system 110 may generate a healthcare transaction for the order. The transaction may include line items for each action that is expected to occur with relation to the order, such as preparing the medication for the order, delivering the medication for the order, dispensing the medication for the order, administering the medication for the order, disposing of any excess medication for the order, billing for the administered medication for the order, or generally any action that may occur with relation to the order. The control system 110 may utilize the messages transmitted by the healthcare systems 120A-D and/or the healthcare devices 130A-F to validate when a particular action for the transaction has been completed. The control system 110 may store an indication that the transaction has been cleared, e.g. validated, once all of the actions associated with the transaction have been completed. Alternatively, and/or in addition, the control system 110 may notify a healthcare professional and/or an administrator if any of the actions of the transaction are not completed within a period of time. An example process for validating healthcare transactions is discussed further below with respect to FIG. 6.

The control system 110 may provide user identity and notification systems. For example, the control system 110 may authenticate users and may control the access of a user, or a group of users. For example, a physician may be allowed to input orders into a POE system, while a nurse may only be allowed to view the orders in the POE system. Thus, the control system 110 may provide different views of information, e.g. information received from one or more of the healthcare systems 120A-D and/or the healthcare devices 130A-F, to different users based on the users' access privileges. The control system 110 may also provide user interfaces to users, such as via the user devices 140A-C, and may manage the users' interactions with the user interfaces. In one or more embodiments, the control system 110 may provide information for a patient to a user device 140A to be displayed on one of the user interfaces when the control system 110 determines that the user device 140A is within a proximity of the patient and/or within a proximity of one of the healthcare devices 130A-F that is providing, and/or facilitating with providing, healthcare to the patient.

Alternatively, or in addition, the user device 140A may determine that it is located within a proximity of a patient and/or within a proximity of one of the healthcare devices 130A-F. The user device 140A may then transmit an indication to the control system 110 indicating that the user device 140A is located within the proximity of the patient and/or the one of the healthcare devices 130A-F. In response thereto, the control system 110 may transmit information to the user device 140A that pertains to the patient and/or the one of the healthcare devices 130A-F.

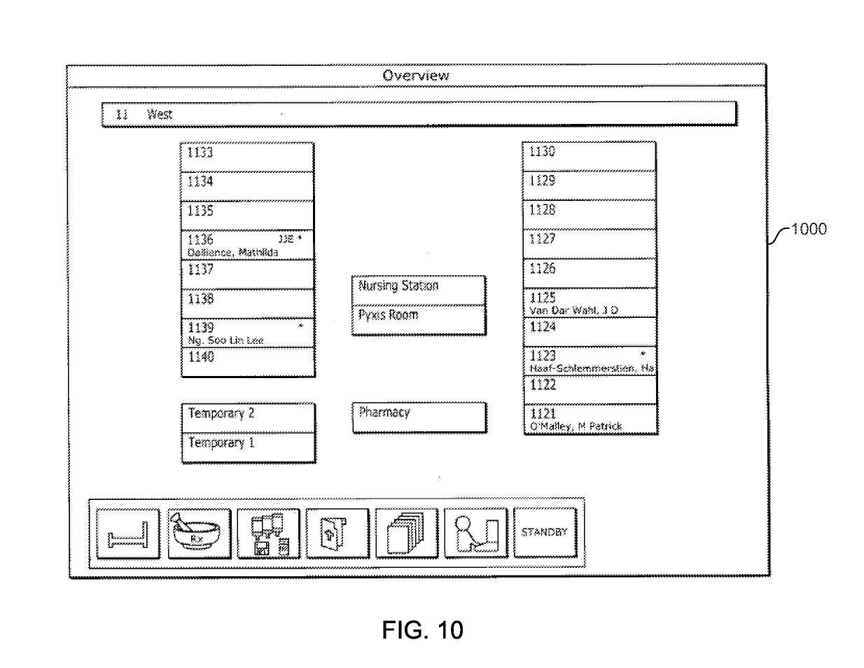

The control system 110 may also transmit notifications to one or more of the users, such as via the user devices 140A-C. For example, the control system 110 may transmit a notification to a user device 140A being accessed by a user, e.g. a user device 140A that the user has authenticated on, when the control system 110 determines that the user is within proximity of a patient who may need care, e.g. a patient that is receiving healthcare from one of the healthcare devices 130A-F that may be experiencing an error. In one or more embodiments, one or more of the notifications may be transmitted to the user devices 140A-C via a user interface. For example, the notification may cause a graphical indicator to be presented on a user interface being displayed on a user device 140A. Example user interfaces for presenting notifications are discussed further below with respect to FIGS. 7 and 10.

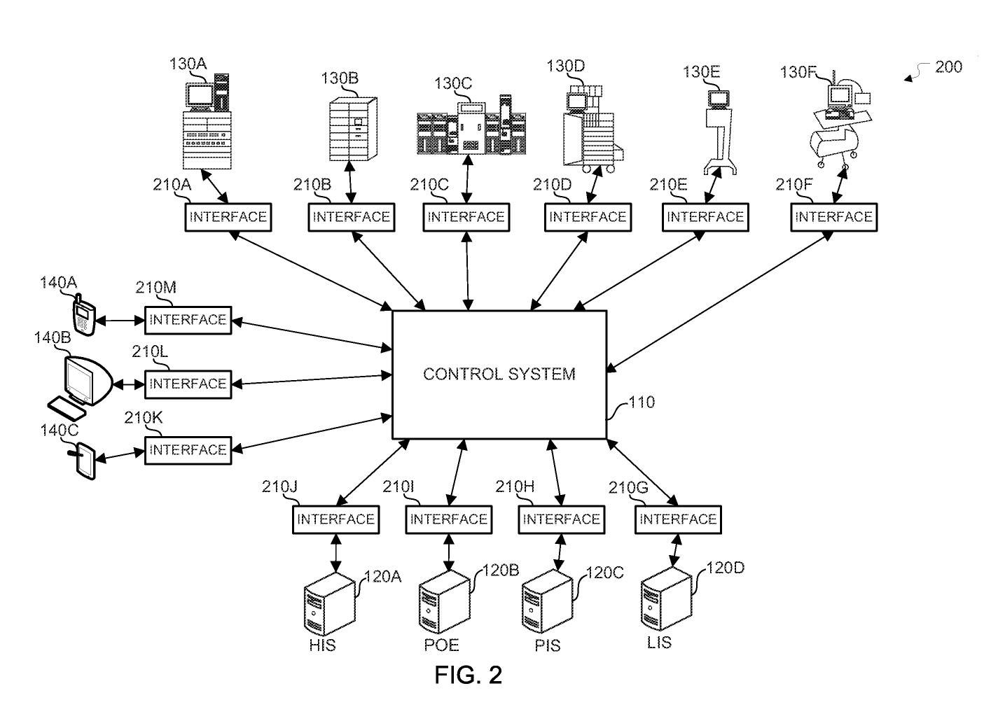

FIG. 2 illustrates an example messaging architecture 200 in which a healthcare validation system may be implemented in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The messaging architecture 200 includes the control system 110, one or more healthcare systems 120A-D, one or more healthcare devices 130A-F, and one or more user devices 140A-C. The control system 110, healthcare systems 120A-D, healthcare devices 130A-F, and user devices 140A-C may be communicably coupled to one another, such as by the network 105 shown in FIG. 1. The one or more healthcare systems 120A-D, one or more healthcare devices 130A-F, and one or more user devices 140A-C may include, and/or may be coupled to, interfaces 210A-M. The interfaces 210A-M may be adapters that are utilized by the one or more healthcare systems 120A-D, one or more healthcare devices 130A-F, and one or more user devices 140A-C to transmit messages to one another via the control system 110. In one or more embodiments, the interfaces 210A-M may be, and/or may include, the adapters described in U.S. patent application Ser. No. 13/421,776, entitled “Scalable Communication System,” filed on Mar. 15, 2012, which is hereby incorporated by reference in its entirety for all purposes.

In one or more embodiments, messages transmitted by the healthcare systems 120A-D, the healthcare devices 130A-F, and/or the user devices 140A-C may be routed through the control system 110, e.g. via the interfaces 210A-M. For example, if a healthcare device 130A is sending a message to the healthcare system 120C, the healthcare device 130A may utilize the interface 210A to transmit the message to the control system 110, and the control system 110 may forward the message to the interface 210H, which provides the message to the healthcare system 120C. In one or more embodiments, the control system 110 may store the messages, such as in the data store 114, for further processing, such as to identify whether to transmit any information indicated in the messages to one or more of the user devices 140A-C, such as via a notification and/or via a user interface.

In one or more embodiments, the control system 110 may include an interface system that receives the messages from one or more of the healthcare systems 120A-D, the healthcare devices 130A-F, and/or the user devices 140A-C, via the interfaces 210A-M. The interface system may provide the interfaces 210A-M to the one or more of the healthcare systems 120A-D, the healthcare devices 130A-F, and the user devices 140A-C, and the one or more of the healthcare systems 120A-D, the healthcare devices 130A-F, and the user devices 140A-C may transmit messages to the interface system by utilizing the interfaces 210A-M.

In one or more embodiments, the interface system receives the messages in a first external format, e.g. a format native to the transmitting device and/or system, converts the messages into an internal messaging format, e.g. for processing and storing the messages, converts the messages into a second external format, e.g. a format native to the receiving device and/or system, and then transmits the messages in the second external format to the receiving device. In one or more embodiments, the first external format may be the same as the second external format. The interface system may be implemented as described, for example, in U.S. patent application Ser. No. 13/421,776, entitled “Scalable Communication System,” filed on Mar. 15, 2012, which has been incorporated by reference in its entirety for all purposes.

Alternatively, or in addition, one or more of the healthcare systems 120A-D, the healthcare devices 130A-F, and/or the user devices 140A-C may communicate with the control system 110 without utilizing the interfaces 210A-M. Alternatively, or in addition, one or more of the healthcare systems 120A-D, the healthcare devices 130A-F, and/or the user devices 140A-C may transmit messages directly to one another, e.g. without routing the messages through the control system 110.

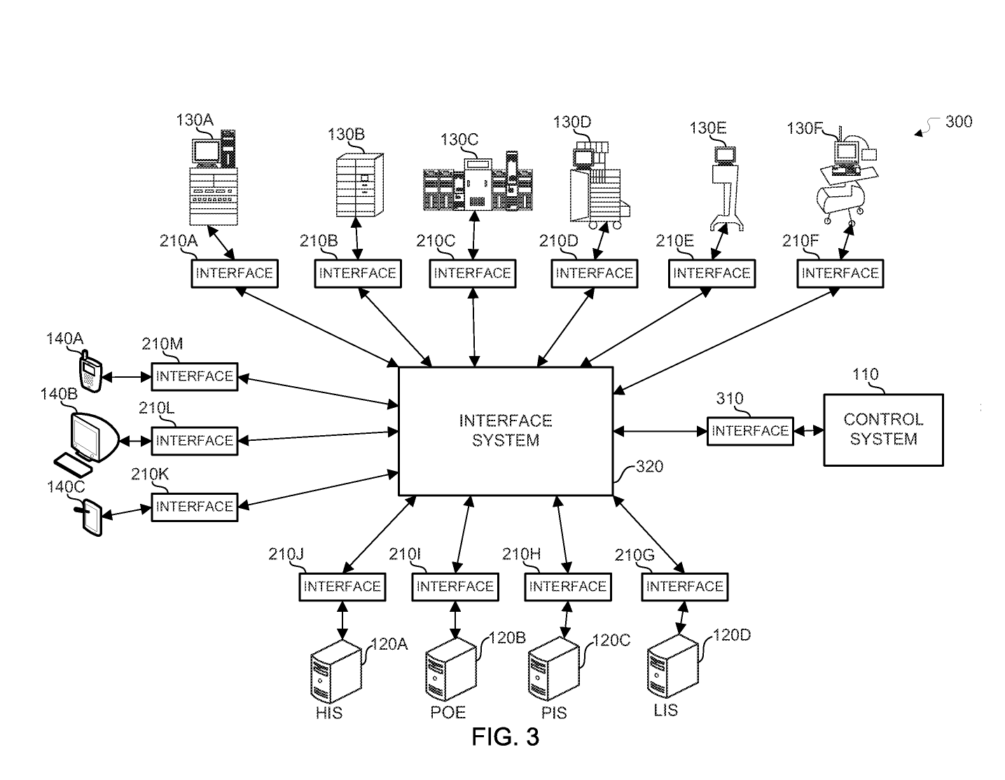

FIG. 3 illustrates an alternative example messaging architecture 300 in which a healthcare validation system may be implemented in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The messaging architecture 300 includes an interface system 320, the control system 110, one or more healthcare systems 120A-D, one or more healthcare devices 130A-F, and one or more user devices 140A-C. The control system 110, interface system 320, healthcare systems 120A-D, healthcare devices 130A-F, and user devices 140A-C may be communicably coupled to one another, such as by the network 105 shown in FIG. 1. The one or more healthcare systems 120A-D, one or more healthcare devices 130A-F, and one or more user devices 140A-C may include, and/or may be coupled to, interfaces 210A-M. The control system 110 may include, and/or may be communicatively coupled to, the interface 310. The interfaces 210A-M, 310 may be adapters that are utilized by the one or more healthcare systems 120A-D, one or more healthcare devices 130A-F, one or more user devices 140A-C, and control system 110 to transmit messages to one another via the interface system 320. In one or more embodiments, the interfaces 210A-M, 310 may be, and/or may include, the adapters described in U.S. patent application Ser. No. 13/421,776, entitled “Scalable Communication System,” filed on Mar. 15, 2012, which was previously incorporated by reference in its entirety for all purposes.

In the messaging architecture 300, the interface system 320 may be separate from the control system 110, e.g. such that messages to/from the control system 110 are routed through the interface system 320. For example, the control system 110 and the interface system 320 may be separate devices, such as separate servers, or the control system 110 and the interface system 320 may be and/or may include distinct hardware on the same device. Alternatively, the control system 110 may receive messages directly from the interface system 320, e.g. without the use of the interface 310. Thus, in the messaging architecture 300, messages are routed through the interface system 320, rather than through the control system 110, as previously discussed with respect to FIG. 2.

Alternatively, or in addition, one or more of the healthcare systems 120A-D, the healthcare devices 130A-F, the user devices 140A-C, and/or the control system 110 may communicate with the interface system 320 without utilizing the interfaces 210A-M, 310. Alternatively, or in addition, one or more of the healthcare systems 120A-D, the healthcare devices 130A-F, the user devices 140A-C, and/or the control system 110 may transmit messages directly to one another, e.g. without routing the messages through the interface system 320.

FIG. 4 illustrates a flow diagram of an example process 400 for a healthcare validation system in accordance with one or more embodiments. For explanatory purposes, the example process 400 is described herein with reference to the healthcare system 120C (PIS) of the example network environment 100 of FIG. 1; however, the example process 400 is not limited to the healthcare system 120C of the example network environment 100 of FIG. 1. For example, in one or more embodiments the example process 400 may be performed by the control system 110 of FIG. 1, any of the healthcare systems 120A, B, D of FIG. 1, and/or the interface system 320 of FIG. 3. Further for explanatory purposes, the blocks of the example process 400 are described herein as occurring in serial fashion, or linearly. However, multiple blocks of the example process 400 may occur in parallel. In addition, the blocks of the example process 400 need not be performed in the order shown and/or one or more of the blocks of the example process 400 need not be performed.

In block 402, the healthcare system 120C (PIS) receives orders for medications from the healthcare system 120B (POE). For example, the healthcare system 120B may receive orders for medications, such as from a physician, and the healthcare system 120B may transmit the orders over the network 105 to the healthcare system 120C. In block 404, the healthcare system 120C receives information items pertaining to the progresses of the deliveries of the orders for medications from one or more of the healthcare devices 130A-F, such as while the healthcare devices 130A-F are delivering the medications. For example, the healthcare devices 130A-F may transmit messages over the network 105 to the healthcare system 120C. Any message may indicate the progress of the delivery of a medication to a patient, such as an indication that the medication has been received, e.g. an IV bag has been hung, an indication that the delivery of the medication has been initiated, an indication that a certain amount of the medication has been delivered, an indication that the delivery of the medication is complete, and/or generally any indication regarding the progress of the delivery of a medication.

In block 406, the healthcare system 120C may provide at least a portion of the received orders for the medications and the information items pertaining to the progress of the deliveries of the medications, such as to a display and/or one of the user devices 140A-C. For example, the healthcare system 120C may display the at least the portion of the received orders and the information items on a screen and/or a display. Alternatively, or in addition, the healthcare system 120C may transmit the at least the portion of the received orders and the information items to one of the user devices 140A-C, such as the user device 140A, over the network 105. Alternatively, or in addition, the healthcare system 120C may process the received orders and/or the received information items to generate processed information, and the healthcare system 120C may provide the processed information to the display and/or the user device 140A.

In one or more embodiments, the user device 140A may display at least the portion of the orders and information items, such as to a healthcare professional. The healthcare professional may compare the orders and information items to determine whether any discrepancies exist between the medications that were ordered and the medications that are being delivered. If the healthcare professional identifies a discrepancy, the healthcare professional may interact with the user device 140A to select the order for which there is a discrepancy. The user device 140A may then transmit an indication of the order for which there is a discrepancy to the healthcare system 120C.

In block 408, the healthcare system 120C may receive an indication that the discrepancy exists, such as from the user device 140A over the network 105. In block 410, the healthcare system 120C may transmit an alert to one of the user devices 140A-C, such as the user device 140B, that indicates that the discrepancy exists, e.g. that corrective action is required, that a safety issue exists and/or that an error exists. In one or more embodiments, the healthcare system 120C may determine that the user device 140B is proximally located to the one of the healthcare devices 130A-F that is administering the medication for the order that has the discrepancy. In block 412, the healthcare system 120C may store the indication of the discrepancy in a data store. For example, the healthcare system 120C may store the indication in a local data store and/or a remote data store, such as the data store 114.

In one or more embodiments, the healthcare system 120C may use an index to rate, or score, one or more of the discrepancies, e.g. based on a level of severity or a level of seriousness of the discrepancy. For example, a discrepancy with a high level of severity, such as a patient receiving an incorrect medication, may be rated higher than a discrepancy with a lower level of severity. The healthcare system 120C may use the rating of a discrepancy to determine which of the user devices 140A-C to alert to the discrepancy. For example, the healthcare system 120C may alert the user devices 140A-C of multiple nurses and/or multiple physicians for a discrepancy having a high level of severity, while the healthcare system 120C may only alert the user device 140A of a nurse for a discrepancy having a low level of severity. Alternatively, or in addition, if an alert for a discrepancy is not responded to within a configurable amount of time, the healthcare system 120C may increase the severity of the discrepancy and/or may send the alert to the user devices 140A-C of additional healthcare professionals.

FIG. 5 illustrates a flow diagram of an example process 500 for a healthcare validation system in accordance with one or more embodiments. For explanatory purposes, the example process 500 is described herein with reference to the control system 110 of the example network environment 100 of FIG. 1; however, the example process 500 is not limited to the control system 110 of the example network environment 100 of FIG. 1. For example, in one or more embodiments the example process 500 may be performed by any of the healthcare systems 120A-D of FIG. 1, and/or the interface system 320 of FIG. 3. Further for explanatory purposes, the blocks of the example process 500 are described herein as occurring in serial fashion, or linearly. However, multiple blocks of the example process 500 may occur in parallel. In addition, the blocks of the example process 500 need not be performed in the order shown and/or one or more of the blocks of the example process 500 need not be performed.

In block 502, the control system 110 may receive an order for a medication to be delivered to a patient, such as from one of the healthcare systems 120A-D over the network 105. For example, the control system 110 may receive a message containing an order for a medication that is being transmitted from the healthcare system 120B (POE) to the healthcare system 120C (PIS). The order may include one or more parameters pertaining to the delivery of the medication, such as the type of medication to be delivered, the amount of the medication to be delivered, the rate of delivery of the medication, and/or any other parameters related to the delivery of the medication.

In block 504, the control system 110 may receive, from one of the healthcare devices 130A-F, such as the healthcare device 130A, an information item pertaining to the delivery of a medication to the patient. For example, the healthcare device 130A may transmit the information item over the network 105 to the control system 110. In one or more embodiments, the information item may include one or more parameters pertaining to the delivery of the medication, such as the type of medication being delivered, the amount of medication being delivered, the rate of delivery of the medication, and/or any other parameters related to the delivery of the medication.

In block 506, the control system 110 may validate that the medication being delivered to the patient corresponds to the medication that was ordered for the patient, based on the received order and the received information item. For example, the control system 110 may compare the parameters of the order with the parameters of the information item to determine whether there are any discrepancies. If the parameters of the order are substantially equivalent to the parameters of the information item, the control system 110 may validate that the correct medication is being delivered to the patient. However, if any of the parameters of the order are substantially different from the corresponding parameters of the information item, the control system 110 may not validate the medication being delivered to the patient.

Alternatively, or in addition, the control system 110 may display and/or transmit at least a portion of the information item and the order, such as to a user device 140A. The user device 140A may present the order and the information item to a healthcare professional, and the healthcare professional may identify whether there are any discrepancies. The user device 140A may then transmit an indication of any identified discrepancies to the control system 110.

If, in block 508, the control system 110 did not validate the medication being delivered, the control system 110 moves to block 510. In block 510, the control system 110 transmits an alert to one of the user devices 140A-C, such as the user device 140B, that indicates that the medication was not validated, e.g. that corrective action is required, that a safety issue exists and/or that an error exists. In one or more embodiments, the healthcare system 120C may determine that the user device 140B is proximally located to the healthcare device 130A that is administering the medication. If, in block 508, the control system 110 validated the medication being delivered, the control system 110 moves to block 512. In block 512, the control system 110 stores an indication of whether the medication being delivered was validated, such as in the data store 114.

FIG. 6 illustrates a flow diagram of an example process 600 for a healthcare validation system in accordance with one or more embodiments. For explanatory purposes, the example process 600 is described herein with reference to the control system 110 of the example network environment 100 of FIG. 1; however, the example process 600 is not limited to the control system 110 of the example network environment 100 of FIG. 1. For example, in one or more embodiments the example process 600 may be performed by any of the healthcare systems 120A-D of FIG. 1, and/or the interface system 320 of FIG. 3. Further for explanatory purposes, the blocks of the example process 600 are described herein as occurring in serial fashion, or linearly. However, multiple blocks of the example process 600 may occur in parallel. In addition, the blocks of the example process 600 need not be performed in the order shown and/or one or more of the blocks of the example process 600 need not be performed.

In block 602, the control system 110 may receive an order for a medication to be delivered to a patient from one of the healthcare systems 120A-D. For example, the control system 110 may receive a message, that includes an order for a medication, that is being transmitted from the healthcare system 120B (POE) to the healthcare system 120C (PIS). The order may include one or more parameters pertaining to the delivery of the medication, such as the type of medication to be delivered, the amount of the medication to be delivered, the rate of delivery of the medication, and/or any other parameters related to the delivery of the medication.

In block 604, the control system 110 generates a transaction for the order. The transaction may include a line item for each action that is expected to occur with respect to the order. For example, the actions may include preparing the medication for the order, delivering the medication for the order, dispensing the medication for the order, administering the medication for the order, disposing of any excess medication for the order, billing for the administered medication for the order, or generally any action that may occur with relation to the order. In one or more embodiments, the transaction may also include conditional line items. For example, the transaction may include a conditional line item for disposing of excess medication, where the line item only needs to be validated if the amount of medication administered is substantially less than the amount of the medication that was dispensed. The control system 110 may store the transaction, such as in the data store 114.

In block 606, the control system 110 receives a first message that indicates that the medication was dispensed. The first message may further include one or more parameters related to dispensing the medication, such as the amount of the medication that was dispensed, the healthcare professional to whom the medication was dispensed, the time at which the medication was dispensed, or generally any information related to dispensing the medication. In one or more embodiments, the control system 110 may receive the first message that indicates that the medication was dispensed from one of the healthcare devices 130A-F over the network 105, such as from an automated dispensing machine. The control system 110 may validate, or clear, the line item of the transaction that is associated with dispensing the medication when the first message is received, if the parameters of the first message coincide with the parameters of the order. In one or more embodiments, the control system 110 may transmit a message to the one of the healthcare devices 130A-F if the parameters of the first message do not coincide with the parameters of the order.

In block 608, the control system 110 receives a second message that indicates that the medication was administered to the patient. The second message may further include one or more parameters related to administering the medication, such as the amount of the medication that was administered, the healthcare professional who administered the medication, the time at which the medication was administered, or generally any information related to administering the medication. In one or more embodiments, the control system 110 may receive the second message that indicates that the medication was administered from one of the healthcare devices 130A-F over the network 105, such as from a healthcare device 130A that administered the medication and/or that facilitated with administering the medication. The control system 110 may validate, or clear, the line item of the transaction that is associated with administering the medication when the second message is received, if the parameters of the second message coincide with the parameters of the order. In one or more embodiments, the control system 110 may transmit a message to the healthcare device 130A if the parameters of the second message do not coincide with the parameters of the order.

In block 610, the control system 110 receives a third message that indicates that the patient was billed for the administered amount of the medication. The third message may further include one or more parameters related to billing the patient for the medication, such as the amount of medication that the patient was billed for, the time at which the patient was billed, or generally any information related to billing the patient for the administered medication. In one or more embodiments, the control system 110 may receive the third message that indicates that the patient was billed for the administered amount of the medication from one of the healthcare systems 120A-D over the network 105, such as from the healthcare system 120A (HIS) and/or from an accounting system. The control system 110 may validate, or clear, the line item of the transaction that is associated with billing for the medication when the third message is received, if the parameters of the third message coincide with the parameters of the order and/or if the amount of medication that the patient was billed for coincides with the amount of medication that was administered to the patient. In one or more embodiments, the control system 110 may transmit a message to the one of the healthcare systems 120A-D if the parameters of the third message do not coincide with the parameters of the order, and/or if the amount of medication that the patient was billed for does not correspond to the amount of medication that was administered to the patient.

In block 612, the control system 110 determines whether the dispensed amount of the medication is substantially equivalent to the administered amount of the medication. The determination by the control system 110 may account for small amounts of the medication that may have been lost, such as in transit of the medication. If, in block 612, the control system 110 determines that the dispensed amount of the medication is not substantially equivalent to the administered amount of the medication, the control system 110 moves to block 614.

In block 614, the control system 110 receives a fourth message that indicates that an excess amount of the medication was disposed of, or wasted. The fourth message may further include one or more parameters related to disposing the excess medication, such as the amount of medication that was disposed, the healthcare professional who disposed the medication, the time that the medication was disposed, or generally any information related to disposing the medication. In one or more embodiments, the control system 110 may receive the fourth message that indicates that the excess medication was disposed from one of the healthcare devices 130A-F over the network 105, such as from a waste station.

In block 616, the control system 110 determines whether the amount of the medication that was disposed plus the amount of the medication that was administered is substantially equivalent to the amount of the medication that was dispensed. If, in block 616, the control system 110 determines that the disposed amount plus the administered amount is not substantially equal to the dispensed amount, the control system moves to block 620. In block 620, the control system 110 indicates that the line item associated with disposing of, or wasting, the medication can not be cleared, or validated, and the control system 110 invalidates the entire transaction.

If, in block 616, the control system 110 determines that the disposed amount plus the administered amount is substantially equal to the dispensed amount, the control system 110 moves to block 618. In block 618, the control system 110 may validate, or clear, the line item of the transaction that is associated with disposing the excess medication and the control system 110 may validate the entire transaction. Similarly, if, in block 612, the control system 110 determines that the dispensed amount is substantially equal to the administered amount, the control system 110 moves to block 618 and validates the entire transaction.

In block 622, the control system 110 stores an indication of whether the transaction was validated, such as in the data store 114. In one or more embodiments, the control system 110 may transmit a notification to a user device 140A of a healthcare professional, or of an administrator, when the transaction was not validated. In one or more embodiments, if the control system 110 is not able to validate, or clear, a line item for a particular action, the control system 110 may transmit an alert, or notification, to one of the user devices 140A-C in order to notify a healthcare professional and/or administrator that a discrepancy exists with respect to the line item.

In one or more embodiments, a transaction, such as a transaction for an order, may not include all of the line items that are discussed above with respect to FIG. 6. Alternatively, or in addition, a transaction, such as a transaction for an order, may include additional line items that are not discussed above with respect to FIG. 6.

FIG. 7 illustrates an example user interface 700 that may be implemented in a healthcare validation system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 700 may display information relating to in-progress actions being performed by one or more of the healthcare devices 130A-F, such as medical orders being administered. For example, the user interface 700 displays a report of IVs that are being administered by, and/or with the facilitation of, one or more of the healthcare devices 130A-F. In one or more embodiments, the administrations of medical orders that will terminate within a preselected time period may be distinguished on the user interface 700 from other administrations by color highlighting or other means. The user interface 700 may further display the time remaining, medication, and patient name, as well as buttons for program control. In one or more embodiments, the user interface 700 may display pending infusions or infusions scheduled to begin within a preselected time period.

In operation, the user interface 700 may be provided by the control system 110, and/or one or more of the healthcare systems 120A-D, for display on a screen, such as a screen of one or more of the user devices 140A-C, and/or a screen or monitor associated with one or more of the healthcare systems 120A-D. For example, the control system 110 may receive messages from one or more of the healthcare devices 130A-F related to actions being performed by the one or more healthcare devices 130A-F. The control system 110 may parse the received messages to obtain the information displayed on the user interface 700, and/or the received messages may be displayed on the user interface 700.

The information displayed on the user interface 700 may be updated in real-time as the control system 110 and/or one or more of the healthcare systems 120A-D receives messages from the healthcare devices 130A-F, such as while orders are being administered to patients. In one or more embodiments, the user interface 700 may be used to modify the preparation of medications, such as by scheduling and/or rescheduling, the preparation of medications.

In one or more embodiments, the user interface 700 may also display notifications, and/or alerts, such as when a healthcare professional is associated with a user device 140A that is displaying the user interface 700. For example, in the user interface 700, the notifications may be indicated by an asterisk (“*”). In one or more embodiments, the healthcare professional may select information that is displayed with an asterisk, such as by touching or clicking on the information, to receive additional information regarding the notification. In one or more embodiments, one or more of the alerts and/or notifications may only be displayed when the healthcare professional is proximally located to the one or more healthcare devices 130A-F to which the alerts and/or notifications pertain.

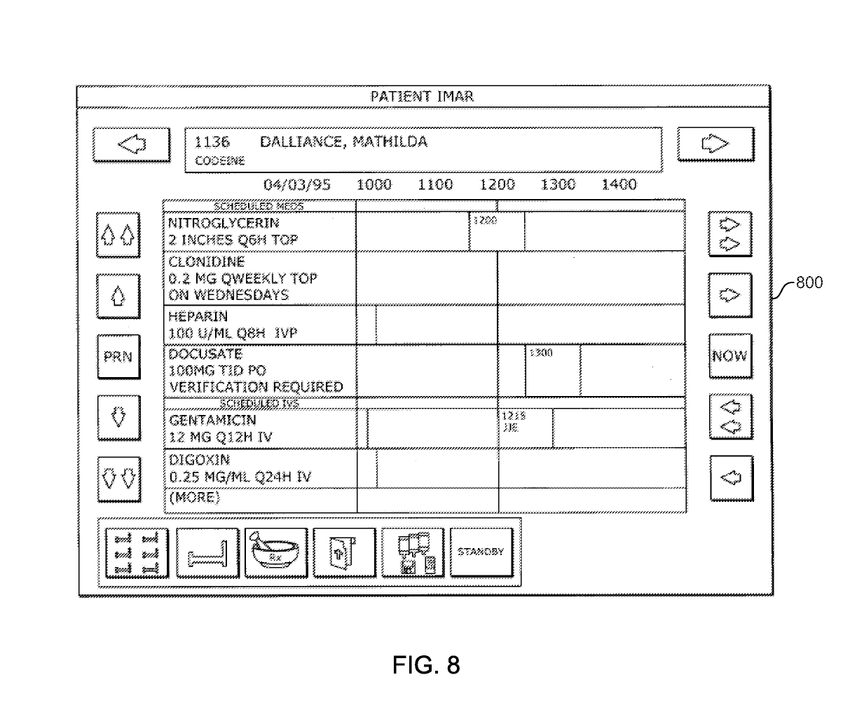

FIG. 8 illustrates an example user interface 800 that may be implemented in a healthcare validation system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 800 may display information relating to a patient, such as information received from one or more of the healthcare systems 120A-C and/or one or more of the healthcare devices 130A-F. The displayed information may include information related to medications and/or infusions, such as IVs, that are scheduled for the patient, and the information may be received from the healthcare system 120C. The information may further include information related to medications and/or infusions that are being administered to the patient and this information may be received from one or more of the healthcare devices 130A-F. For example, the user interface 800 displays information related to scheduled medications and IVs for an identified patient. In one or more embodiments, the user interface 800 may be color coded to indicate the status and schedule of each medication administration. For example, a medication delivery window extending from thirty minutes prior and thirty minutes after the scheduled administration time may be indicated by a yellow band on the user interface 800.

In operation, the user interface 800 may be provided by the control system 110, and/or one or more of the healthcare systems 120A-D, for display on a screen, such as a screen of one or more of the user devices 140A-C, and/or a screen or monitor associated with one or more of the healthcare systems 120A-D. For example, the control system 110 may receive messages from one or more of the healthcare systems 120A-D, and/or one or more of the healthcare devices 130A-F, that relate to a patient. The control system 110 may parse the received messages to obtain the information displayed on the user interface 800, and/or the received messages may be displayed on the user interface 800.

In one or more embodiments, the user interface 800 may automatically be provided to the user device 140A of a healthcare professional when the healthcare professional is located within a proximity of the patient and/or within a proximity of one or more healthcare devices 130A-F that are providing, and/or facilitating with providing, healthcare to the patient. Thus, the user device 140A of a healthcare professional may automatically display, and/or prepare for display, information related to an identified patient when the healthcare professional is within proximity of the patient, such as at the bedside of the patient. Accordingly, the information displayed on the user interface 800 may change as the healthcare professional moves throughout the healthcare facility.

In one or more embodiments, the user device 140A may receive information for displaying the user interface 800 when the healthcare professional is proximally located to the patient, but the user device 140A may not display the user interface 800 until prompted by the healthcare professional. For example, the user device 140A may receive the information for displaying the user interface 800 and may then display a notification to the healthcare professional indicating that the information is available, and requesting whether the healthcare professional would like the user interface 800 to be displayed on the user device 140A and/or on a display or monitor proximally located to the user device 140A.

The information displayed on the user interface 800 may be updated in real-time as the control system 110 and/or one or more of the healthcare systems 120A-D receives messages from the healthcare devices 130A-F, such as while orders are being administered to the patient. In one or more embodiments, the user interface 800 may be used to schedule and/or reschedule, the preparation of medications, such as by the healthcare system 120C.

The information displayed on the user interface 800 may be updated in real-time as the control system 110 and/or one or more of the healthcare systems 120A-D receives messages from the healthcare devices 130A-F and/or the healthcare systems 120A-D, such as while orders are being administered to patients, while orders are being prepared for administration to patients, and/or when orders are received from a physician order entry system. In one or more embodiments, the user interface 800 may be used to verify the administration of orders, such as a healthcare professional verifying that a medication scheduled for administration and/or a medication being administered coincides with the ordered medication. In one or more embodiments, a healthcare professional may be able to select, such as touch or click on, an order and the user interface 800 may display a picture of the medication being administered, or about to be administered.

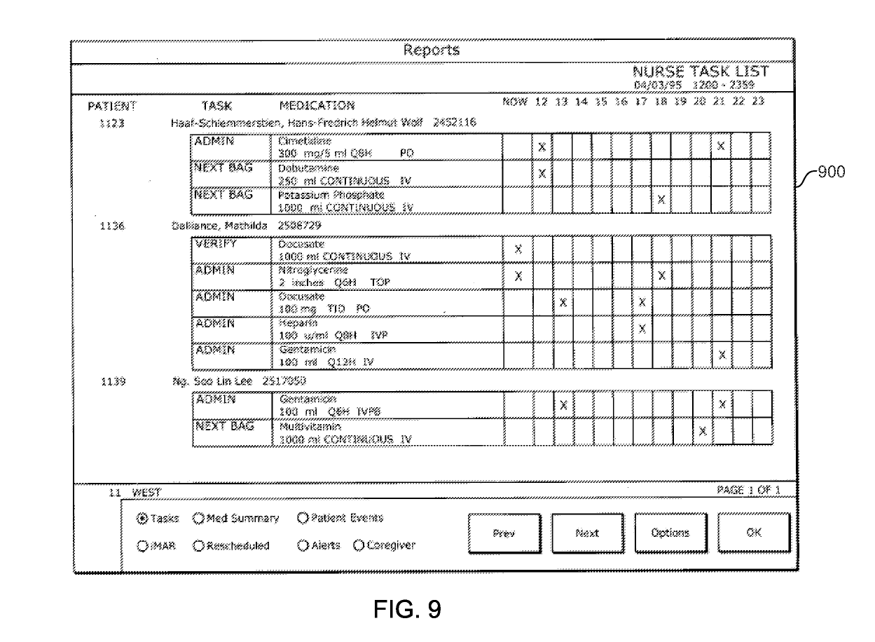

FIG. 9 illustrates an example user interface 900 that may be implemented in a healthcare validation system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 900 may display information to an identified healthcare professional that relates to in-progress actions being performed by, and/or with the facilitation of, one or more of the healthcare devices 130A-F, and for which the healthcare professional is facilitating and/or monitoring. The user interface 900 may also display information to the identified healthcare professional that relates to future actions to be performed by, and/or with the facilitation of, one or more of the healthcare devices 130A-F, and for which the healthcare professional is facilitating and/or monitoring. Alternatively, or in addition, the user interface 900 may display information related to in-progress or future actions that are being performed proximally to the user device 140A, and a healthcare professional accessing the user device 140A. For example, the user interface 900 displays a report of IVs that are being administered by one or more of the healthcare devices 130A-F. In one or more embodiments, the user interface 900 may include scheduling of medication administrations to ensure proper medication of the patient while distributing the workload over a period of time to ensure that all medication is given promptly.

In operation, the user interface 900 may be provided by the control system 110, and/or one or more of the healthcare systems 120A-D, for display on a screen, such as a screen of one or more of a user devices 140A being accessed by a healthcare professional, and/or a screen or monitor associated with one or more of the healthcare systems 120A-D. For example, the control system 110 may receive messages from one or more of the healthcare systems 120A-D, and/or one or more of the healthcare devices 130A-F, that relate to in-progress actions and/or future actions that are being performed with the facilitation of the healthcare professional, and/or that are being performed proximally to the healthcare professional, as indicated by the location of the user device 140A. The control system 110 may parse the received messages to obtain the information displayed on the user interface 900, and/or the received messages may be displayed on the user interface 900.

In one or more embodiments, the user interface 900 may automatically be provided to the user device 140A of a healthcare professional when the healthcare professional is located within a proximity of the patient and/or within a proximity of one or more healthcare devices 130A-F that are providing, and/or facilitating with providing, healthcare to one or more patients. Thus, the user device 140A of a healthcare professional may automatically display, and/or prepare for display, information related to in-progress and/or future actions that are being performed, and/or will be performed, proximally to the location of the healthcare professional. Accordingly, the information displayed on the user interface 900 may change as the healthcare professional moves throughout the healthcare facility.

In one or more embodiments, the user device 140A may receive information for displaying the user interface 900 when the healthcare professional is proximally located to in-progress, or future actions, but the user device 140A may not display the user interface 900 until prompted by the healthcare professional. For example, the user device 140A may receive the information for displaying the user interface 900 and may then display a notification to the healthcare professional indicating that the information is available, and requesting whether the healthcare professional would like the user interface 900 to be displayed on the user device 140A and/or on a display or monitor proximally located to the user device 140A.

The information displayed on the user interface 900 may be updated in real-time as the control system 110 and/or one or more of the healthcare systems 120A-D receives messages from the healthcare devices 130A-F, such as while orders are being administered to patients. In one or more embodiments, the user interface 900 may be used to verify the administration of orders, such as a healthcare professional verifying that a medication scheduled for administration and/or a medication being administered coincides with the ordered medication. In one or more embodiments, a healthcare professional may be able to select, such as touch or click on, an order and the user interface 900 may display a picture of the medication being administered, or about to be administered.

FIG. 10 illustrates an example user interface 1000 that may be implemented in a healthcare validation system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 1000 may display information relating to patients in a healthcare facility and/or in an area of a healthcare facility, such as alerts or notifications related to healthcare being administered to patients in a healthcare facility. For example, the user interface 1000 may display a graphical representation of each room in an area of the healthcare facility, the name of the patient occupying each room, if any, and any alerts or notifications that apply to any of the displayed patients. In the user interface 1000, an alert or notification is indicated by an asterisk (“*”); however, any other graphical indicator may be used to indicate an alert and/or notification.

In operation, the user interface 1000 may be provided by the control system 110, and/or one or more of the healthcare systems 120A-D, for display on a screen, such as a screen of one or more of the user devices 140A-C, and/or a screen or monitor associated with one or more of the healthcare systems 120A-D. For example, the control system 110 may receive messages from one or more of the healthcare devices 130A-F related to actions being performed by the or more healthcare devices 130A-F. The control system 110 may parse the received messages to determine whether any alerts and/or notifications should be displayed via the user interface 1000, such as whether any discrepancies and/or errors are identified from the received messages.

In one or more embodiments, the user interface 1000 may automatically be provided to the user device 140A of a healthcare professional when the healthcare professional is located within a proximity of the area of the healthcare facility represented on the user interface 1000. Thus, the user device 140A of a healthcare professional may automatically display, and/or prepare for display, the user interface 1000 when a healthcare professional is proximally located to the represented area. Accordingly, the information displayed on the user interface 1000 may change as the healthcare professional moves throughout the healthcare facility.

In one or more embodiments, the user device 140A may receive information for displaying the user interface 1000 when the healthcare professional is located proximally to the represented area, but the user device 140A may not display the user interface 1000 until prompted by the healthcare professional. For example, the user device 140A may receive the information for displaying the user interface 1000 and may then display a notification to the healthcare professional indicating that the information is available, and requesting whether the healthcare professional would like the user interface 1000 to be displayed on the user device 140A and/or on a display or monitor proximally located to the user device 140A.

The information displayed on the user interface 1000 may be updated in real-time as the control system 110 and/or one or more of the healthcare systems 120A-D receives messages from the healthcare devices 130A-F, such as while orders are being administered to patients.

In one or more embodiments, the user interface 1000 may display the status of each patient's infusion, and when an alert occurs, the box representing the patient's room flashes red to attract attention to the alert. Accordingly, a healthcare professional accessing the user interface 1000 may be able to quickly and easily identify the patient from the user interface, such as at a nursing station, and take appropriate action to address the condition causing the alert. In one or more embodiments, certain alerts that have been identified as particularly important events may be displayed on multiple screens throughout the healthcare facility, such as in the pharmacy.

In one or more embodiments, the user interface 1000 may also be used for updating administrative records of the healthcare facility. For example, if a patient changes rooms, a healthcare professional can transmit a notification of the room change to the control system 110 by selecting the patient's name, and dragging that patient to the new room. In addition, the user interface 1000 may be updated to reflect the room change.

FIG. 11 conceptually illustrates electronic system 1100 with which one or more embodiments of the subject technology may be implemented. Electronic system 1100, for example, can be, or can include, the control system 110, the interface system 320, one or more of the healthcare systems 120A-D, one or more of the healthcare devices 130A-F, one or more of the user devices 140A-C, a desktop computer, a laptop computer, a tablet computer, a phone, a personal digital assistant (PDA), and/or generally any electronic device that transmits signals over a network. Such an electronic system includes various types of computer readable media and interfaces for various other types of computer readable media. Electronic system 1100 includes bus 1108, processing unit(s) 1112, system memory 1104, read-only memory (ROM) 1110, permanent storage device 1102, input device interface 1114, output device interface 1106, and network interface 1116, or subsets and variations thereof

Bus 1108 collectively represents all system, peripheral, and chipset buses that communicatively connect the numerous internal devices of electronic system 1100. In one or more embodiments, bus 1108 communicatively connects processing unit(s) 1112 with ROM 1110, system memory 1104, and permanent storage device 1102. From these various memory units, processing unit(s) 1112 retrieves instructions to execute and data to process in order to execute the processes of the subject disclosure. The processing unit(s) can be a single processor or a multi-core processor in different embodiments.

ROM 1110 stores static data and instructions that are needed by processing unit(s) 1112 and other modules of the electronic system. Permanent storage device 1102, on the other hand, is a read-and-write memory device. This device is a non-volatile memory unit that stores instructions and data even when electronic system 1100 is off. One or more embodiments of the subject disclosure use a mass-storage device (such as a magnetic or optical disk and its corresponding disk drive) as permanent storage device 1102.

Other embodiments use a removable storage device (such as a floppy disk, flash drive, and its corresponding disk drive) as permanent storage device 1102. Like permanent storage device 1102, system memory 1104 is a read-and-write memory device. However, unlike storage device 1102, system memory 1104 is a volatile read-and-write memory, such as random access memory. System memory 1104 stores any of the instructions and data that processing unit(s) 1112 needs at runtime. In one or more embodiments, the processes of the subject disclosure are stored in system memory 1104, permanent storage device 1102, and/or ROM 1110. From these various memory units, processing unit(s) 1112 retrieves instructions to execute and data to process in order to execute the processes of one or more embodiments.

Bus 1108 also connects to input and output device interfaces 1114 and 1106. Input device interface 1114 enables a user to communicate information and select commands to the electronic system. Input devices used with input device interface 1114 include, for example, alphanumeric keyboards and pointing devices (also called “cursor control devices”). Output device interface 1106 enables, for example, the display of images generated by electronic system 1100. Output devices used with output device interface 1106 include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

Finally, as shown in FIG. 11, bus 1108 also couples electronic system 1100 to a network (not shown) through network interface 1116. In this manner, the computer can be a part of a network of computers (such as a local area network (“LAN”), a wide area network (“WAN”), or an Intranet, or a network of networks, such as the Internet. Any or all components of electronic system 1100 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more embodiments, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more embodiments, the computer readable media is non-transitory computer readable media, computer readable storage media, or non-transitory computer readable storage media.

In one or more embodiments, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system, comprising:
one or more processors; and
a memory including instructions that, when executed by the one or more processors, cause the one or more processors to:
receive a plurality of orders from a healthcare system over a communication network, each order identifying one of a plurality of medications to be delivered to one of a plurality of patients;
receive a plurality of information items from a plurality of healthcare devices, each information item pertaining to a progress of delivery of one of the plurality of medications to one of the plurality of patients, the delivery being facilitated by one of the plurality of healthcare devices;
provide at least a portion of the plurality of information items and at least a portion of the plurality of orders for display;
receive an indication that a discrepancy exists between one of the plurality of information items and a corresponding one of the plurality of orders; and
store the indication in a data store.

2. The system of claim 1, wherein the discrepancy comprises at least one of an error or a safety issue.

3. The system of claim 2, wherein the instructions, when executed by the one or more processors, further cause the one or more processors to:
transmit an alert to a user device upon receiving the indication that the discrepancy exists, wherein the alert indicates that corrective action is required.

4. The system of claim 3, wherein the user device is located proximally to the healthcare device that is facilitating the delivery of the medication for which the discrepancy exists.

5. The system of claim 1, where the instructions, when executed by the one or more processors, cause the one or more processors to:
transmit the at least the portion of the plurality of information items and the at least the portion of the plurality of orders to a user device over the communication network; and
receive the indication that the discrepancy exists from the user device over the communication network.

6. The system of claim 1, where the instructions, when executed by the one or more processors, cause the one or more processors to:
display the least the portion of the plurality of information items and the at least the portion of the plurality of orders.

7. A method for validating medications being delivered to patients, the method comprising:
receiving an order for a medication from a healthcare system;
receiving, from at least one healthcare device, at least one information item pertaining to progress of delivery of the medication to a patient, wherein the at least one healthcare device facilitates the delivery of the medication to the patient;
validating the medication being delivered to the patient based at least in part on the received order and the received at least one information item; and
storing an indication of whether the medication being delivered to the patient was validated.

8. The method of claim 7, wherein validating the medication being delivered to the patient based at least in part on the received order and the received at least one information item comprises determining whether a discrepancy exists between the medication being delivered to the patient and the medication of the order.

9. The method of claim 8, further comprising:
determining a severity score of the discrepancy based at least in part on a severity of the discrepancy;
identifying a healthcare professional to alert and a time to alert the healthcare professional based at least in part on the severity score of the discrepancy; and
transmitting an alert to a user device of the healthcare professional at the identified time.

10. The method of claim 7, further comprising:
transmitting an alert to a user device of a healthcare professional when the medication being delivered to the patient is not validated.

11. The method of claim 10, wherein the at least one information is received while the medication is being delivered to the patient.

12. The method of claim 7, wherein the order is received from the healthcare over a communication network.

13. The method of claim 12, wherein the healthcare system comprises at least one of a pharmacy information system, a hospital information system, or a physician order entry system.

14. The method of claim 13, wherein the at least one healthcare device comprises an infusion device or a smart bed.

15. The method of claim 13, wherein the at least one healthcare device comprises a patient feeding device, a smart bed, an infusion device, a drug delivery device, a patient monitoring device, or a respiratory device.

16. The method of claim 15, wherein the drug delivery device comprises a drug dispensing device and the respiratory device comprises a ventilator.

17. A non-transitory machine readable medium embodying instructions that, when executed by a machine, cause the machine to perform a method for validating healthcare transactions, the method comprising:
receiving an order for administration of a medication to a patient with facilitation of a healthcare device;
generating and storing a transaction for the order, wherein the transaction comprises a plurality of line items corresponding to a plurality of actions related to the order, wherein a first line item corresponds to transmitting the order to the healthcare device, a second line item corresponds to completing the administration of the order to the patient with the facilitation of the healthcare device, and a third line item corresponds to updating an accounting system with respect to the administration of the order to the patient;
receiving a first message that indicates that the order has been transmitted to the healthcare device;
receiving a second message that indicates that the administration of the order to the patient has been completed;
receiving a third message that indicates that the accounting system has been updated with respect to the administration of the order to the patient; and
validating the transaction when the first, second, and third messages are received.

18. The non-transitory machine readable medium of claim 17, the method further comprising:
storing an indication that the transaction was validated when the first, second, and third messages are received.

19. The non-transitory machine readable medium of claim 17, wherein the first message is received from a healthcare system, the second message is received from the healthcare device, and the third message is received from the accounting system.

20. The non-transitory machine readable medium of claim 19, wherein the healthcare system comprises at least one of a pharmacy information system, a hospital information system, or a physician order entry system and the healthcare device comprises an infusion device or a smart bed.

21. The non-transitory machine readable medium of claim 19, wherein the healthcare device comprises a patient feeding device, a smart bed, an infusion device, a drug delivery device, a patient monitoring device, or a respiratory device.

22. The non-transitory machine readable medium of claim 19, wherein the plurality of line items further comprises a fourth line item that corresponds to dispensing the medication to a healthcare professional, and the method further comprising:
receiving a fourth message that indicates that the medication was dispensed to a healthcare professional, and indicates a dispensed amount of the medication.

23. The non-transitory machine readable medium of claim 22, wherein the fourth message is received from an automated dispensing machine.

24. The non-transitory machine readable medium of claim 23, wherein the second message further indicates an administered amount of the medication.

25. The non-transitory machine readable medium of claim 24, wherein the plurality of line items further comprises a fifth line item that corresponds to disposing the medication, and the method further comprising:
receiving a fifth message that indicates that the medication was disposed by the healthcare professional, and indicates a disposed amount of the medication.

26. The non-transitory machine readable medium of claim 25, wherein the fourth message identifies the healthcare professional to whom the medication was dispensed, and the fifth message identifies the healthcare professional who disposed of the medication.

27. The non-transitory machine readable medium of claim 26, wherein the first, second, third, fourth, and fifth messages are received over a communication network.

28. The non-transitory machine readable medium of claim 27, wherein validating the transaction when the first, second, and third messages are received further comprises validating the transaction when the first, second, third, and fourth messages are received if the administered amount of the medication is substantially equal to the dispensed amount of the medication, otherwise validating the transaction when the first, second, third, fourth, and fifth messages are received if the administered amount plus the disposed amount is substantially equal to the dispensed amount.

29. The non-transitory machine readable medium of claim 28, further comprising transmitting a notification when the transaction is not validated within a time period.

30. The non-transitory machine readable medium of claim 29, wherein the transmitting the notification further comprises transmitting the notification over a communication network to a user device.
